(19) United States
(12) Patent Application Publication
(10) Pub. No.: US 2021/0109332 A1
(43) Pub. Date: Apr. 15, 2021

(54) OPTICAL SYSTEM FOR AN LED WASH LUMINAIRE

(71) Applicant: Heinz Heinz Grether, Austin, TX (US)

(72) Inventors: Danielle DILEO, Toronto (US); Jean-Francois CANUEL, Toronto (US)

(73) Assignee: Heinz Heinz Grether, Austin, TX (US)

(21) Appl. No.: 16/877,775

(22) Filed: May 19, 2020

Related U.S. Application Data
(63) Continuation of application No. 15/199,183, filed on Jun. 30, 2016, now abandoned.

(51) Int. Cl. G02B 19/00; F21K 9/68; F21V 14/04; G02B 3/08; G02B 27/09; F21V 5/00; F21V 13/04; F21V 5/04; H05B 47/155

(52) U.S. Cl. CPC G02B 19/0066; F21K 9/68; F21V 14/04; G02B 3/08; G02B 27/0955; F21Y 2115/10; F21V 13/04; F21V 5/045; G02B 19/0028; G02B 19/0061; H05B 47/155; F21V 5/004

(57) ABSTRACT

An optical system for an LED wash luminaire employing an lens with a first Fresnel functional surface and a second functional surface comprised of a plurality of out of focus microlenses in bands of different focal lengths in combination with specially shaped reflector(s) to achieve a more even light distribution on a surface area with a wide range of distances from the luminaire.

### RELATED APPLICATION

The present application is a continuation application of application Ser. No. 15/199,183 filed on 30 Jun. 2016 of the same title.

### TECHNICAL FIELD OF THE INVENTION

The present invention generally relates to an optical system for an LED wash luminaire, specifically to optical systems and methods relating to providing flat, smooth light distribution from a wash luminaire.

### BACKGROUND OF THE INVENTION

Luminaires for entertainment use have commonly been manufactured from arrays of light emitting elements, often Light Emitting Diodes or LEDs, mounted into a housing. Examples of such systems can be seen in U.S. Pat. Nos. 5,752,766, 5,752,766, 6,908,214 and in the products and patents of Color Kinetics Inc. of Boston, Mass.

The entertainment lighting market was historically controlled by mature technologies based on incandescent, fluorescent, mercury short-arc lamps, quartz halogen, xenon, metal halide, and other 20th century light sources.

In the entertainment lighting market the majority of early LED based products consisted of light emitting diodes without optics such as wash lights which produce a simple diffuse illumination with little or no control of the light beam. The majority of these lighting fixtures are constructed in a simple housing with no means of controlling the shape and directionality of the light. A common usage for these products is to light a flat wall, cyclorama, or other scenic element of a stage, studio, or other entertainment production as shown in FIGS. 11 and 12 of this document. Placing a simple device with no controlling optics on the ground close to such a wall and simply angling the light up the wall to provide grazing illumination inevitably results in large variation of the brightness of the illumination as you move up the wall, with the bottom significantly brighter than the top. There are also problems with the overlap between adjacent luminaires again producing uneven and inadequate illumination. An ideal wash light product of this type would be capable of being placed close to the wall or cyclorama, and produce smooth, even illumination across the whole surface.

Altman Lighting describe a system using LEDs designed for this purpose in U.S. Pat. No. 8,152,332 to Ryan. This uses a shaped reflector to direct the light from multiple LEDs against a wall or cyclorama. However, this unit has limited homogenization of colors along the length of the unit and can produce visible color banding.

The problem is exacerbated when multiple colors of LEDs are used in an additive mixing configuration. For example, it is common to use red, green, and blue LED emitters in a mixing configuration with separate intensity controls for each of the types of LED so as to allow the user to mix substantially any color needed. However, the simple optics of prior art systems inadequately mix the colors resulting in blotches of uneven color on the lit surface, and poor mixing. It is also a large, and relatively inflexible, unit with no control over the optical system.

There is a need for a method for producing and controlling a light beam from an LED sourced wash light luminaire to provide flatter, smoother light distribution from a wash luminaire. Additionally, the system should mix multiple colors of LEDs such that a single color is perceived by a viewer.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates side cross sectional view of an embodiment of an optical system of an improved light distribution wash luminaire;

FIG. 2 illustrates detail of a side cross sectional view of two embodiments 20a and 20b of output lens of the embodiment of the optical system of FIG. 1;

FIG. 3 illustrates a view of a first face (rearward facing) of an embodiment of an output lens;

FIG. 4 illustrates in side cross-sectional views details of optional embodiments 20 on the left and 20 in the center for the first face of an output lens with greater detail of facet 26 varying step angles 28a, 28b and 28c to shown to the right;

FIG. 5a illustrates a view of a second face of an embodiment of an output lens;

FIG. 5b illustrates a view of a second face of an alternative embodiment of an output lens(s);

FIGS. 6a & 6b illustrate the optical alignment of the output lens in a luminaire utilizing the invention;

FIGS. 7a &7b illustrate the optical alignment of the output lens in an alternative embodiment of an improved light distribution wash luminaire;

FIG. 8a illustrates side cross sectional view detail of an embodiment of a reflector in and embodiment of an optical system;

FIG. 8b illustrates front view detail of an embodiment of a reflector in an embodiment of an optical system;

FIG. 9 illustrates isometric view detail of an embodiment of a reflector in an embodiment of the optical system;

FIG. 10 illustrates an isometric rendering of an embodiment of an improved wash luminaire using two of the reflectors illustrated in FIGS. 8a, 8b, and 9;

FIG. 11 illustrates a side view of an embodiment of the invention in use in situ with a wall or cyclorama; and;

FIG. 12 illustrates a rear view of an embodiment of the invention in use in situ with a wall or cyclorama.

### DETAILED DESCRIPTION OF THE INVENTION

Preferred embodiments of the present invention are illustrated in the Figures, like numerals being used to refer to like and corresponding parts of the various drawings.

The present invention generally relates to an optical system for an LED wash luminaire, specifically to optical systems and methods relating to providing flat, smooth light distribution from a wash luminaire. It is a further intent of the invention that the front face of the luminaire shall provide a homogeneous panel of light to the eye of a viewer minimizing the appearance of individual sources.

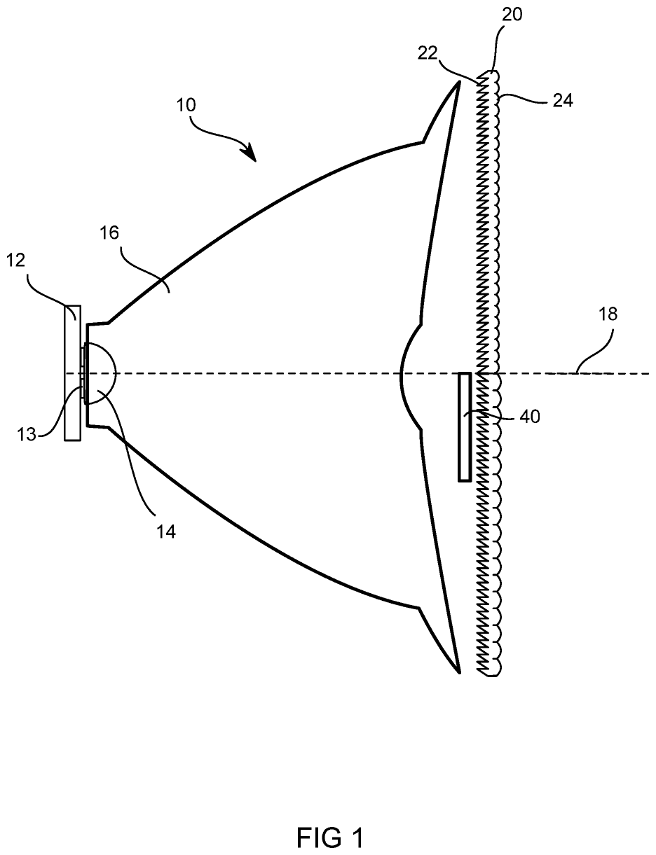

FIG. 1 illustrates an embodiment 10 of the optical system of a wash luminaire of the invention. Light emitting module 13 is mounted to circuit board 12. Light emitting module 13 may comprise a single LED 13 or an array of LEDs. Each LED may be paired with a primary optic on each LED (not shown) or an array of LED or groups in an array may be paired with primary optics 14. Light emitting module 13 may contain a single color of LEDs or may contain multiple LEDs, each of which may be of common or differing colors. For example, in one embodiment light emitting module 13 may comprise Red, Green, Blue and Amber LEDs.

The light from light emitting module 13 is emitted along optical axis 18 and impinges on and is controlled by reflector 16. Reflector 16 may be elliptical, parabolic, or spherical in cross section. In a further embodiment 16 may utilize an aspheric cross-section constructed so as to optimally control the light output through the remainder of the optical system. Reflector 16 may be manufactured of aluminum, glass, plastic, or any other material as well known in the art. Light from reflector 16 is thus constrained to pass through lens 20 and optional diffuser 40. Lens 20 is of asymmetrical construction and server to both homogenize and control the light from the reflector such that it is optimally directed onto a wall or cyclorama as a smooth even wash light.

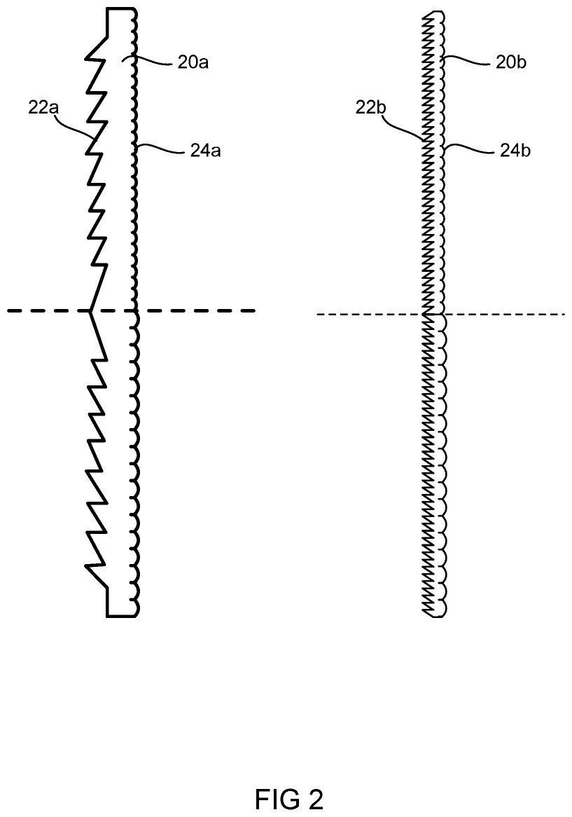

FIG. 2 illustrates the cross sectional detail of two embodiments of lens 20, shown as 20a and 20b. Looking first at lens 20a. The first surface 22a of lens 20a is a Fresnel lens structure formed by molding or otherwise forming circumferential ridges or facets in the surface of the lens material. Each of these ridges may form a small cross section of a convex lens such that the entire surface behaves like a convex lens with proscribed focal length. The general design and construction of conventional Fresnel lenses surface is well known in the art. The first surface of the lens may be a coarse Fresnel lens as shown by 22a on lens 20a or a fine Fresnel lens as shown by 22b on lens 20b.

Still on FIG. 2, the second surface 24a of lens 20a is formed as an array or multiple arrays of microlenses. These microlenses may be all of a single focal length, or may be of differing focal lengths arranged generally in bands across surface 24a of lens 20a. Microlenses 24a may be meniscus lenses, plano convex lenses, bi-convex lenses, holographic lenses, aspheric lenses, or other similar functioning lenses as well known in the art. Lens 20a may be constructed of glass, transparent plastic or other optically transparent material as known in the art.

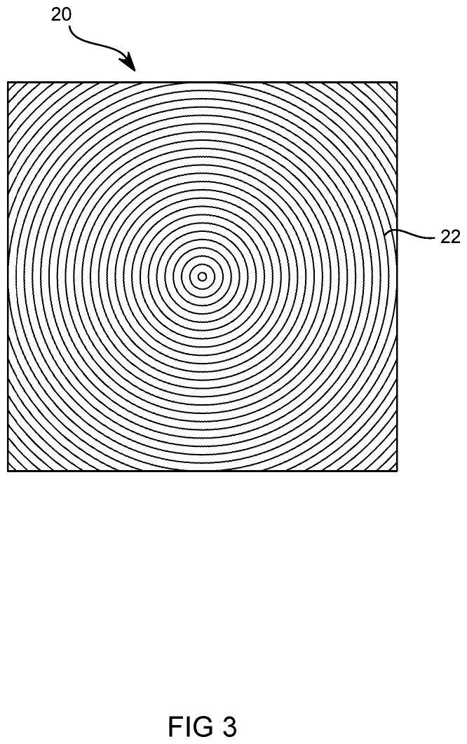

FIG. 3 illustrates a plan view of the first face 22 of an embodiment of lens 20 showing the symmetry of the facets of the Fresnel lens about a central point.

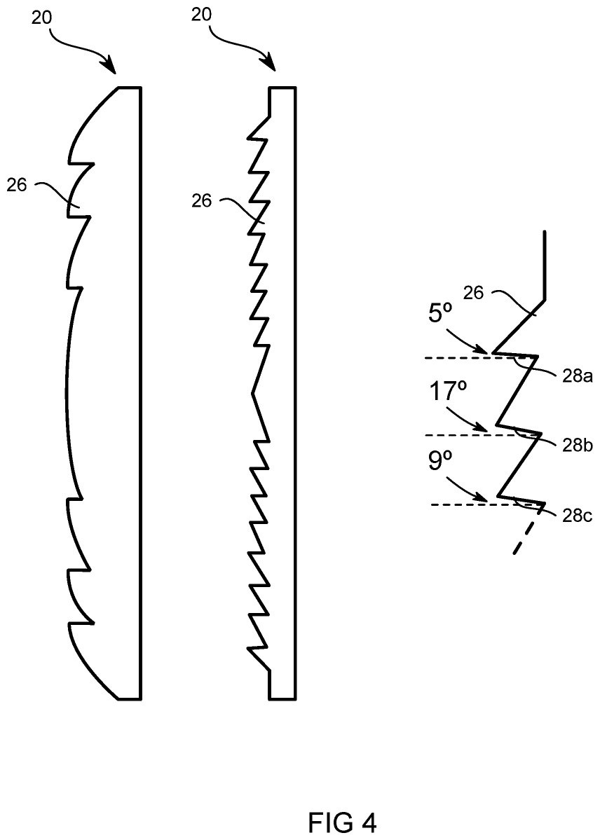

FIG. 4 illustrates further embodiments of the Fresnel lens providing the first face of lens 20. Facets or ridges 26 may be either curved or flat faced. A feature of Fresnel lens design is the step that each facet 26 makes back to the main surface of the lens. In conventional Fresnel lens design this step is either vertical, or as close to vertical as the manufacturing process allows. In the preferred embodiment the step angles 28a, 28b and 28c of adjacent facets are varied one embodiment of such variance is illustrated to the far right in FIG. 4. The variation may be random over a range of angles. For example, FIG. 4 shows one facet at 5° to the vertical, another at 17° to the vertical and a third at 9° to the vertical. In practice every facet step may be at a differing, random or pseudo-random, angle over a range to the vertical.

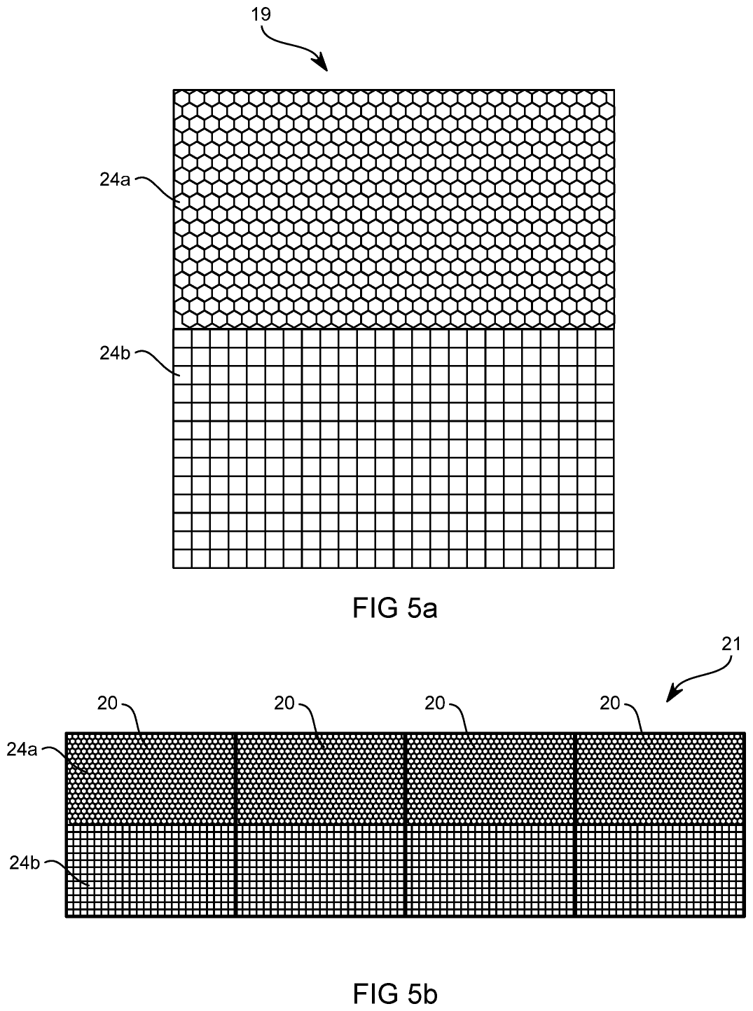

FIGS. 5a and 5b illustrate a plan views of two embodiments of the second face of lens 19 and 21 showing in more detail the arrays of microlenses 24a and 24b. In the embodiments illustrated microlens array 24a comprises a hexagonal array of microlenses while microlens array 24b comprises a square array of microlenses. The invention is not so limited and, in practice, any array shape of microlenses may be used without departing from the invention. For example, the arrays may be linear, square, hexagonal, octagonal, circular, or random. As previously described, the microlens arrays may be positioned in bands across lens 19 and 21. FIGS. 5a and 5b show two bands, 24a and 24b. In the embodiment illustrated, microlenses 24a are of a shorter focal length than microlenses 24b. This results in a narrower beam angle for the light passing through microlenses 24a than the light passing through microlenses 24b. In an embodiment of the invention, the narrow light beams from microlenses 24a are directed towards the further portions of the wall or cyclorama while the wider light beams from microlenses 24b are directed towards the closer portions of the wall or cyclorama. Thus the light is more evenly distributed across the wall. The figures illustrate two focal power bands, in alternative embodiments more than two focal powers may be used and more power bands may be configured on the second surface of the output lens.

The FIG. 5b illustrates how multiple lens 20 may be stacked side by side to form a linear wash light lens 21. In the embodiment shown the lens 21 is comprised of separate lens units 20. In alternative embodiments the lens units 20 may be part of a single large lens structure 21. However, the invention is not so limited and any arrangement of lenses 20 may be used

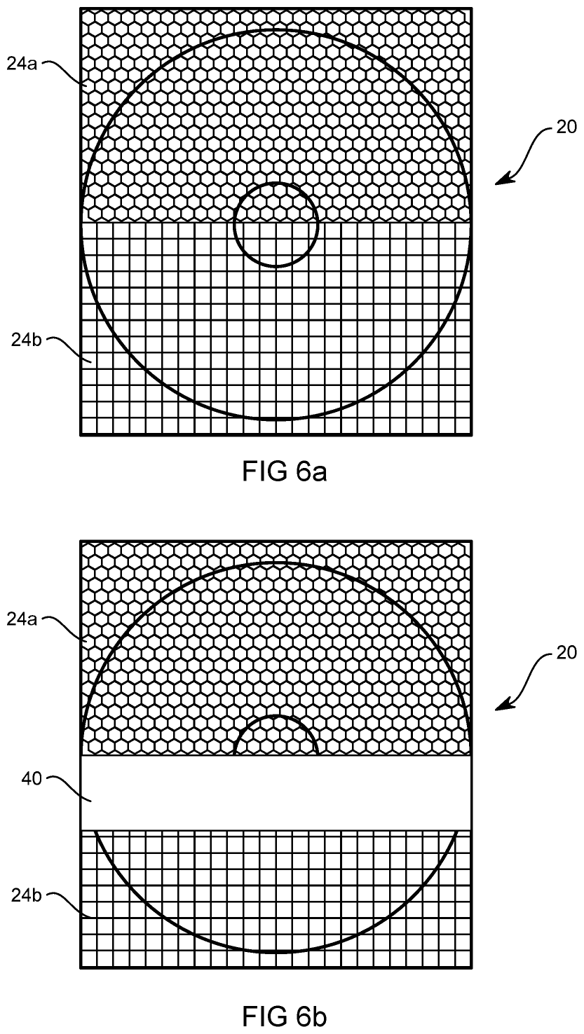

FIG. 6a illustrates how lens 19 or 21 may be aligned with the light source and reflector. In the embodiment shown in FIG. 6a, microlens array 24a and microlens array 24b meet at the center line of the light source and reflector. However, the invention is not so limited and the microlens arrays may be positioned anywhere across the light beam as the specific situation requires. In a preferred embodiment as a cyclorama light the arrangement is as shown in FIG. 6a. FIG. 6b shows the same arrangement as FIG. 6a but with the optional diffusion filter 40 added to the system. Diffusion filter 40 servers to further soften the light output, improve homogenization, and optically blend the juncture between the microlens arrays.

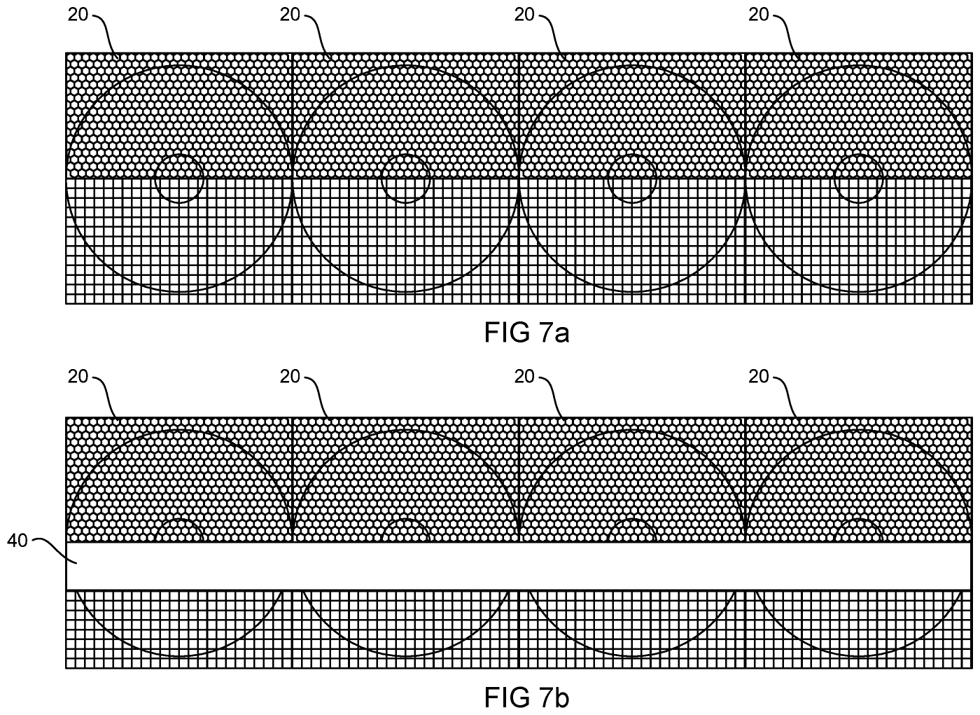

FIG. 7 illustrates the optical alignment of the lenses in luminaire utilizing an embodiment of the invention. In the embodiment shown the luminaire utilizes four of the optical systems in a linear array. Each of the four has its own light source, reflector and lens. Diffuser 40 may optionally be added to the system as shown in FIG. 7b.

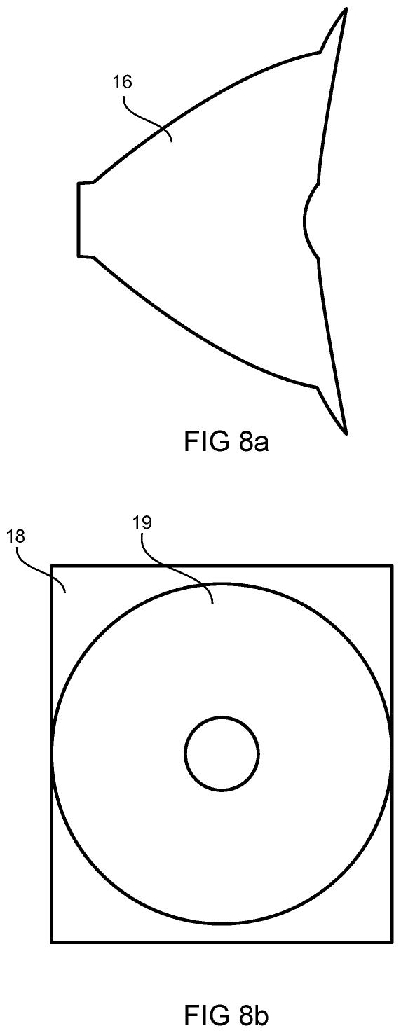

FIG. 8 provides further detail of an embodiment of reflector 16 in the optical system. As previously described reflector 16 may be of substantially conventional construction in portion 19 which forms the main light beam of the luminaire as directed towards lens 20 (not shown). As an improvement over the prior art reflector 16 has angled edges or flanges, 18. Instead of being at 90° to the optical path as is usual in the prior art, these flanges are at an angle such that a portion of the light from the light source impinges on them and is reflected into the corners of the lens. These flanges serve to fill in the area between the circular reflector 16, and the rectangular lens 20. Thus the curved triangular flanges 18 are illuminated so that the front of the luminaire presents a visually pleasing unbroken bar of light rather than distinct circles.

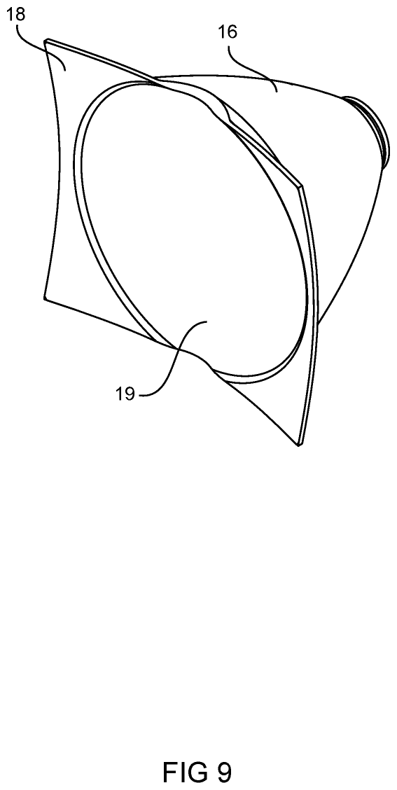

FIG. 9 shows an isometric view of an embodiment of reflector 16 more clearly showing the curved flanges 18 that fill in the corners around circular portion 19.

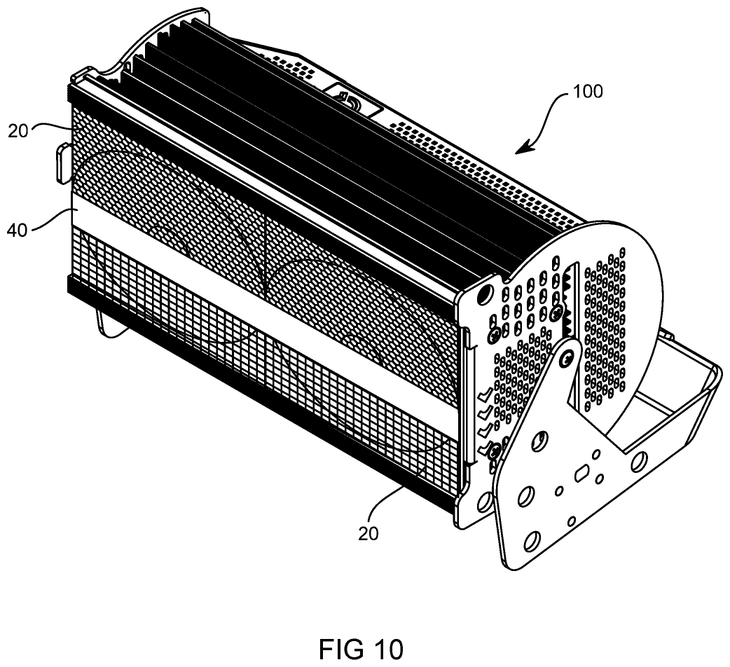

FIG. 10 illustrates an isometric rendering of a wash luminaire 100 using an embodiment of the invention. In the luminaire illustrated the there are two optical systems each with their own lens 20 mounted side by side. Optional diffuser 40 is shown in place cross both lenses 20.

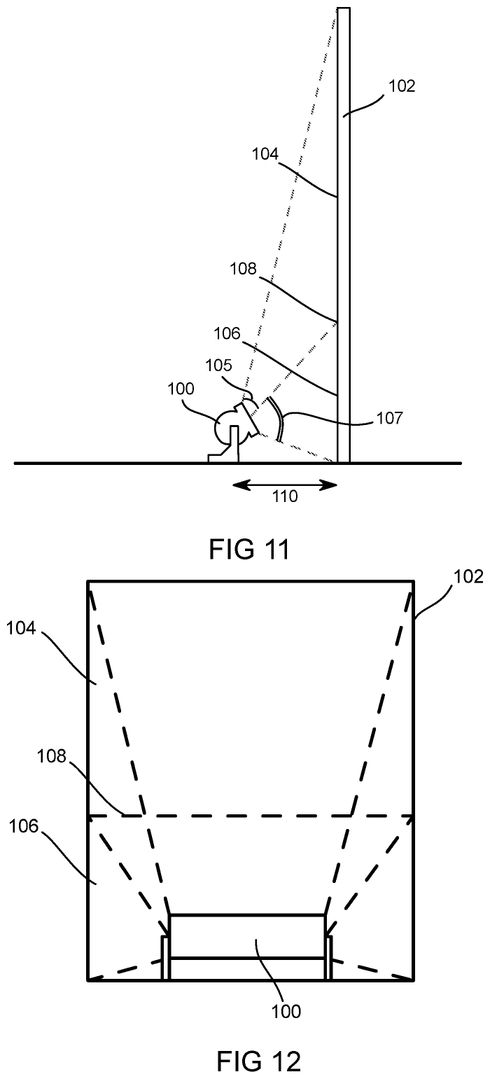

FIGS. 11 and 12 illustrate an embodiment of the invention in use with a wall or cyclorama. Wash luminaire 100 is positioned aimed at wall or cyclorama 102. The separation 110 between luminaire 100 and wall 102 is small. The top half of the light beam, passing through the shorter focal length microlens array is directed towards the top of wall 102 onto area 104. Similarly, the lower half of the light beam, passing through the longer focal length microlens array is directed towards the bottom of wall 102 onto area 106. The outputs from the two microlens arrays overlap and merge around area 108. As the top area 104 of wall 102 is further away, the narrower beam angle 105 introduced by the shorter focal length microlenses serves to constrain the light beam to the desired area. Conversely, light at the bottom area 106 is close to the luminaire and thus needs to be spread out to a wider beam angle 107 through the longer focal length lenses to cover the area. FIG. 11 clearly shows that beam angle 105 must be significantly smaller than beam angle 107, even though wall top area 104 is larger than wall bottom area 106. Prior art systems using the same lenses for all beams cannot achieve this. While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

1-13. (canceled)

14. A wash luminaire comprising:
light source(s),
reflector(s),
lens(es) with
a first Fresnel functional surface and
a second opposing functional surface comprising an array of microlenses which include at least two types of microlenses which differ by shape/optical characteristic where at least one type of microlenses focuses light about a linear axis and the microlenses individual focal axes are not colinear.

15. claim 14 where the at least one type of microlenses individual linear axes are parallel to each other.

16. claim 14 where a second set of microlenses focus light about individual linear axis and the microlenses individual focal axes are not colinear but the second set of microlenses have different focal lengths than the first set of microlenses.

17. The wash luminaire of claim 14 wherein said microlenses with common qualities are generally grouped together.

18. The wash luminaire of claim 17 where the array is arranged/grouped generally into bands of microlenses with common optical qualities.

19. The wash luminaire of claim 17 where the difference in optical qualities relates to the effective focal lengths of the microlenses.

20. The wash luminaire of claim 14 further comprising a diffusing light modulator along the length of a boundary between the bands formed of different arrays of microlenses.

21. The wash luminaire of claim 14 which further comprises a diffusing light modulator positioned to only effects a portion of the light output passing through a single band of common optical qualities but not the other band(s).

22. The wash luminaire of claim 14 where the reflector(s) transition from a circular output (perpendicular to the source) cross sectional shape to a more straight edge shape mimicking edges of the output.

23. The wash luminaire of claim 14 where the microlenses have relatively straight edged cross sectional shapes.

24. The wash luminaire of claim 23 where the microlenses are relatively square.

25. The wash luminaire of claim 23 where the microlenses are relatively hexagonal.

26. The wash luminaire of claim 14 where the microlenses are generally round.

27. A wash luminaire comprising:
light source(s) generating light,
reflector(s) with generally circular cross sections transitioning to more linear edges to result in a more polygon cross section in order to generate more even appearing non-circular light output,
len(es) with a first Fresnel functional surface and a second functional surface comprising a plurality of bands each comprised of an array of microlenses where the individual focal axes of the individual microlenses are parallel but not colinear and the microlenses are arranged into bands that have different effective focal lengths.

28. A wash luminaire comprising:
light source(s),
reflector(s),
lens(es) with
a first Fresnel functional surface and
a second functional surface comprising an array of microlenses which include at least two types of microlenses which differ by shape/optical characteristics including non-colinear individual microlense light axes for axis of at least one type of microlenses and different focal lengths for different types of microlenses resulting in light beam output with intensionally uneven light distribution.
